(19) United States
(12) Patent Application Publication
(10) Pub. No.: US 2013/0105249 A1
(43) Pub. Date: May 2, 2013

(54) LIFT SHAFT DOOR UNLOCKING MECHANISM

(71) Applicant: Markus Henseler, Immensee (CH)

(72) Inventor: Markus Henseler, Immensee (CH)

(73) Assignee: INVENTIO AG, Hergiswil NW (CH)

(21) Appl. No.: 13/696,701

(22) PCT Filed: May 1, 2011
(86) PCT No.: PCT/CH11/00095

§ 371 Date: Jan. 18, 2013

(30) Foreign Application Priority Data
May 7, 2010 (CH) 704/10

(51) Int. Cl. B66B 13/02

(52) U.S. Cl. CPC B66B 13/02
USPC 187/315

(57) ABSTRACT

An elevator shaft door unlocking mechanism has expander skates on the door drive to unlock the elevator shaft door when entering the region close to an access level. The skates are flexible with respect to the elevator car such that, in the event of any touching of the elevator shaft head, they are flexible over an adjustable distance, and, after the elevator car moves away from the elevator shaft head, they assume their original position. The skates are displaceably mounted on the expander skate construction along respective guides, are held in the uppermost displacement position by tension springs, and are displaced downwardly against the force of these springs through application of force to the upper ends from above resulting from a collision with the elevator shaft head. After the upper ends have been released, they are returned to the uppermost displacement position again by the springs.

### FIELD

This invention relates to a device for the unlocking of elevator shaft doors with expander skates, for example, metal rails with ends curved slightly inward, that is to say toward one another, at the top and bottom.

### BACKGROUND

These two skates are located at the upper marginal region of the elevator car door and therefore travel together with the latter and project upward beyond the elevator car. They are connected to one another in an articulated manner at two connecting shackles, the shackles being mounted at their center in each case pivotably about an axle pin on a mounting plate. This therefore gives rise to a parallelogram, so that the skates are expanded away from one another counterclockwise, along with the pivoting of the shackles connecting them, from a position of rest in which said skates are closed and lie opposite one another at unequal height, the left lying somewhat higher than the right. The skate arranged on the left of the shackles is in this case pivoted to the left and downward away from that arranged on the right, and this skate arranged on the right is conversely pivoted away to the right and upward from the skate arranged on the left.

The most recent elevator drive structures allow a minimum shaft head height of only 240 cm. This is the dimension from the uppermost floor up to the underside of the elevator shaft head, that is to say to the ceiling of the elevator shaft. An elevator to be installed there should nevertheless have a car door with a height of 210 cm. Approximately 10 cm are required for the over travel above the car at the top. A height of approximately 15 cm is additionally required for the elevator door drive. In the uppermost normal elevator position, therefore, only approximately 5 cm or even less are left. Thus this space is required as a safety buffer. When the elevator stops with a high load in the uppermost floor, exactly at floor height, and is then relieved of the load, the car may rise a few more cm on account of the elasticity of the carrying cables. Even if the elevator were to travel a few centimeters over the regular uppermost position for drive reasons, it needs a certain clearance for this purpose. Even then, there must still be an air gap up to the elevator shaft head, so that the elevator car can under no circumstances butt against the latter.

The parts on an elevator car which project furthest upward are the expander skates for the shaft door unlocking mechanism which belong to the door drive. If an elevator travels slightly over the regular uppermost position for any reason, there is the risk that these expander skates touch the elevator shaft ceiling with their upper ends and are consequently bent and are then jammed. Such an incident may put the entire elevator installation out of operation, with all the follow up consequences, merely because of one or two slightly bent rails or these skates. People may be trapped in the elevator car, a service and rescue team has to be called and the elevator has to be repaired on site. This may last for hours and cause a lot of trouble for the operator and the users of the elevator.

### SUMMARY

An object of the present invention is, therefore, to specify an elevator shaft door unlocking mechanism in the form of expander skates, which avoids the abovementioned problems.

The object is achieved by an elevator shaft door unlocking mechanism with expander skates on the door drive of the elevator car, which is distinguished in that the skates of the elevator shaft door unlocking mechanism are designed to be flexible, so that, if they accidentally touch the elevator shaft head, they are flexible over an adjustable distance, and, after the elevator car moves away from the elevator shaft head, resume their original position.

### DESCRIPTION OF THE DRAWINGS

This elevator shaft door unlocking mechanism is illustrated, their construction is described and their functioning is explained by means of the drawings in which:

FIG. 1 shows a diagrammatic illustration of the problem with the meager free space above the expander skates and the elevator shaft head;

FIG. 2 shows the upper end region of an elevator car with its door drive and associated elevator shaft door unlocking mechanism in the form of expander skates;

FIG. 3 shows a door locking mechanism of an elevator shaft door in the locked state, to be actuated for unlocking purposes by the expander skates of the door drive of the elevator car; and

FIG. 4 shows a door locking mechanism of an elevator shaft door in the unlocked state, actuated by the expander skates of the door drive of the elevator car.

### DETAILED DESCRIPTION

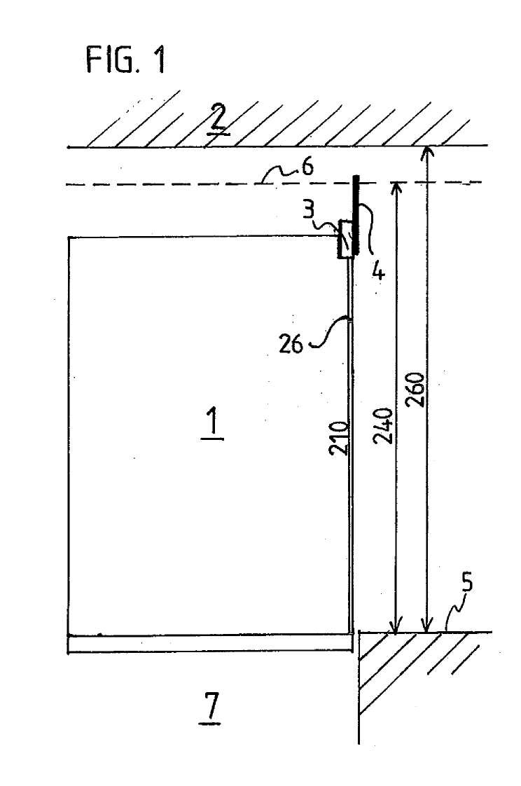

FIG. 1 shows the problem on which this invention is based. An elevator car 1 is shown in its uppermost position, that is to say halted at the uppermost access level 5, in the elevator shaft 7. The elevator shaft head 2 is depicted at the top. The elevator shaft head 2 has a height of 260 cm here at the uppermost access level 5. On top, on the side of the elevator car 1 here on the right, that is to say on the side of its door 26, the door drive 3 is accommodated above it. This door drive includes two expander skates 4 which are illustrated here, as seen from the side, which is why only one of the two expander skates 4 can be seen. An elevator shaft head 6 at the height of only 240 cm from the uppermost access level 5 is indicated by dashes. As can be seen, the upper ends of the depicted expander skates 4 project above the lower boundary of this reduced elevator shaft head 6. If this elevator shaft head 6 were real, the expander skates 4 would collide with the elevator shaft head 6 and would consequently be deformed. These then bent expander skates 4 would damage the entire elevator installation and put it out of operation, with all the adverse consequences. Major outlay would be necessary in order to put the elevator into operation again, not to speak of the outage time always considered troublesome.

However, there is growing pressure to implement ever lower elevator shaft heads and at the same time to install high elevator cars with 210 cm high elevator doors, as depicted. This has hitherto come up against the expander skates which would then be put at great risk and in a limiting situation would be damaged on the elevator shaft head, The elevator door drive 3 requires an additional height of approximately 15 cm on an elevator car 1, thus resulting already in 210 cm plus 15 cm=225 cm, measured from the uppermost access level 5. A further approximately 10 cm is required for overtravel at the top above the car 1, so that this already amounts to 235 cm. This tolerance is too low for any damage to be able to be ruled out, and this is the reason for the present invention.

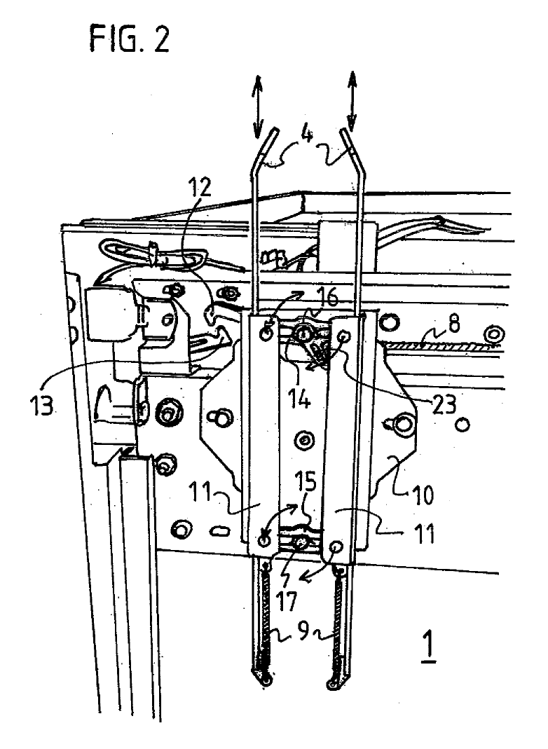

The solution is to design the expander skates 4 to be flexible, so that, in the event of a collision with the elevator shaft head 6, these can flex and then, during the downward travel of the elevator car 1, resume their original position. FIG. 2 shows such a design of the expander skates 4 on an elevator door drive. The elevator car 1 can be seen here, specifically in a view of that side of the elevator car 1 on which a door is present. The image shows in the form of a detail only the left upper marginal region of the elevator 1. The door drive includes an electric motor, not visible here, which drives a toothed belt 8. This toothed belt 8 drags the elevator door, guided laterally on rollers, back and forth after the door drive is released as a result of the disengagement of the pawl 12 from the counter pawl 13. The elevator door and the elevator shaft door should be able to be opened only when the elevator has halted at an access level or is coming to a halt at least directly in front of this access level, that is to say in the final phase of its travel.

The elevator motor for the elevator doors must not merely open the elevator car doors, but also the elevator shaft doors at each access level. This applies whether the elevator car door and associated elevator shaft door are in one part or a multipart and open only onto one side, or the elevator car door and elevator shaft door are composed of two one part or multipart door wings which are pushed away from one another from the middle onto two sides for opening purposes. What serves basically for this is a driver structure, by means of which the elevator shaft doors are drawn along by the elevator car doors being displaced, both for opening and for closing the shaft door or shaft doors. The elevator shaft doors therefore do not have dedicated drives. As a result, only one electric motor is necessary for the elevator car door or elevator car doors and opens this or these and then also closes the respective elevator shaft doors at each access level by drawing them along. This, in turn, should be possible only when the elevator car stands in each case in the correct position with respect to the elevator shaft door.

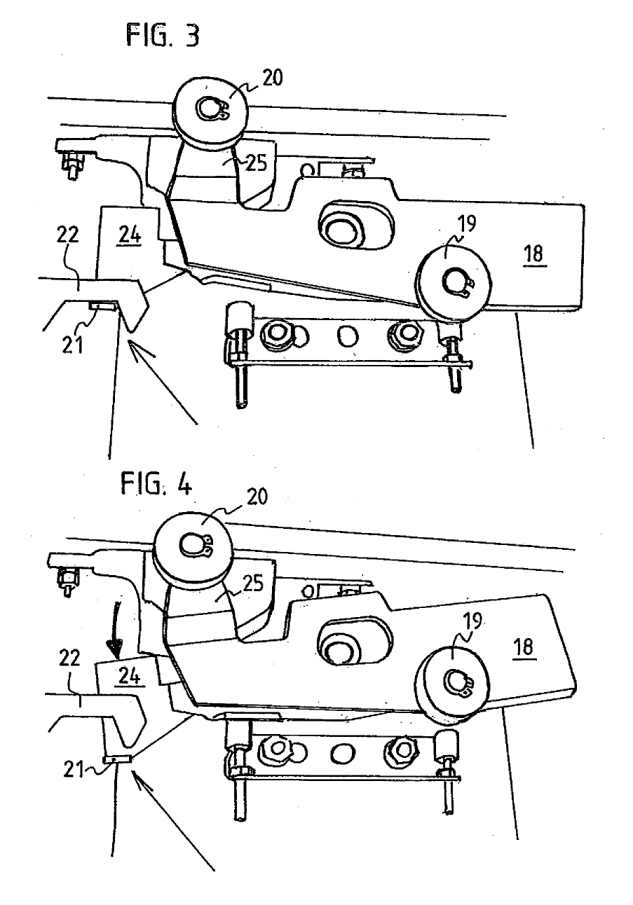

The elevator shaft doors must basically be locked, so that they cannot be opened from outside, so that no one could fall into the empty elevator shaft. An elevator car door unlocking mechanism in the form of expander skates 4 on the door drive of the elevator car serves for unlocking the elevator car door and the elevator shaft doors at each access level. These two skates 4 are arranged on a mounting plate 10 and are guided displaceably in a vertical direction along guides 11, as indicated at the top of the double arrows. The two ends, that is to say the upper and the lower end of the skates 4, are sloped toward one another. Moreover, the guides 11 and therefore also the skates 4 are connected to one another via the connecting shackles 14 and 15 pivotable on the pins 16, 17, so that a parallelogram is formed. The guides 11 with the skates 4 held and guided by them can therefore be pivoted about the pivot axes of the pins 16, 17 of these two shackles 14, 15, that is to say along the two curved double arrows depicted for each guide 11. The guide 11 on the left, with its skate 4, is therefore pivoted clockwise to the right upward, and vice versa, and the guide 11 on the right, with its skate 4, is simultaneously pivoted clockwise to the left and downward, and vice versa. In the state shown, the skates are expanded at the maximum possible distance away from one another and consequently, when the elevator travels onto an access level, actuate the shaft door locking mechanism and unlock it in the interaction with a pawl on the shaft door. The skates are therefore designed with a length such that they can be activated even before the elevator car has reached an access level completely, and therefore the elevator shaft door can be unlocked and the elevator shaft door opened even during the operation of coming to a halt, whether the elevator car comes from below or from above. During the normal travel of the elevator car, that is to say outside the access levels, the skates 4 are pivoted together, that is to say in the end positions according to the curved double arrows depicted. The skates 4 are actuated motively via the upper connecting shackle 14 and its extension 23 as soon as the door opening motor comes into action, this taking place as a result of the arrival of the elevator in the region near an access level which has previously been selected. These two skates 4 are therefore then expanded apart from one another from their closed state, after they have moved from below or above, in this still closed state, between two rollers 19, 20 which are mounted on the shaft door locking mechanism, such rollers being shown in FIGS. 3 and 4. By the skates 4 being expanded apart from one another and the two rollers 19, 20 consequently being pressed away from one another, the pivoting plate 18 to which the rollers 19, 20 are attached is pivoted with its lengthening piece 24 counterclockwise in the drawing, to be precise out of the position, as shown in FIG. 3, into the position, as shown in FIG. 4. The pawl 21 on the lengthening piece 24 is thereby pivoted out of the pawl 22 and the shaft door locking mechanism is consequently unlocked, as is also described in more detail below.

As a particular feature, then, the two skates 4 of this elevator car door locking mechanism are designed to be flexible in relation to the elevator car. This is implemented here in that they are not displaceable upward in the respective guide 11, but instead can be displaced a little way downward. Between the guide 11 and the lower end of the skate 4 carried by it, a tension spring 9 is installed, which therefore constantly draws the skate 4 in the guide 11 upward into its uppermost position within the guide 11. If the skate 4 accidentally touches the elevator shaft head at the upper end of the elevator shaft, it can therefore deviate an adjustable distance downward and the tension spring 9 is correspondingly drawn out. As soon as the elevator car 1 travels away from the elevator shaft head again, the spring 9 pulls the skate 4 back into its original position again.

FIG. 3 shows a view of the locking mechanism in the upper region of an elevator shaft door, that is to say on the elevator shaft, specifically in the locked state of the door. This mechanism then lies directly opposite the elevator shaft door unlocking mechanism, as shown in FIG. 2 and described above, that is to say opposite as if the front side of the drawing sheet with FIG. 2 has been laid onto the front side of the drawing sheet with FIGS. 3 and 4, that is to say face to face. This mechanism on the elevator shaft door is illustrated in FIGS. 3 and 4 and is composed of a pivotal plate 18 which carries two rollers 19, 20, one roller 19 at bottom right and one roller 20 at top left on an upwardly extending lever 25. The pivoting plate 18 extends on the left into a lateral lengthening piece 24 which has at the bottom a pawl 21 angled forward toward the viewing direction of the observer. In the position illustrated, this movable pawl 21 is in mechanical engagement with a stationary pawl 22 on the elevator shaft door. The elevator shaft door, which is connected to the stationary pawl 22, is therefore locked and can be displaced back and forth inside the stationary pawl 22 only within the slight play of the pawl 21. For unlocking purposes, the expander skates 4 travel over the upper side of the elevator car facing the elevator shaft door, in their closed state, first between the two rollers 19, 20 at the pivoting plate 18 from below or from above, depending on from where the elevator car is just coming. At the earliest after their sloped ends have passed the rollers 19, 20 and have therefore travelled past them, the two skates 4 are expanded apart from one another in parallel by the door drive of the elevator car via the extension 23 and the upper connecting shackle 14. The rollers 19, 20 are thereby pressed away from one another, thus generating a torque on the pivoting plate 18 which is consequently pivoted slightly counterclockwise to the direction of the curved arrow in FIG. 4. The pawl 21 thereby moves downward and is pivoted away from the counter pawl 22, and therefore the elevator shaft door is unlocked and is released for lateral displacement.

FIG. 4 shows the same locking mechanism, but in this case in the open state of the locking mechanism. The pivoting plate 18 has been pivoted downward counterclockwise by a few degrees of angle by the two rollers 19, 20 being pressed away from one another and by the intermediate skates 4, so that the pawl 21 has been moved away from the counter pawl 22. The shaft door is consequently unlocked and can be driven by a driver on the elevator door drive and therefore opened and also closed again.

What is essential in this elevator shaft door unlocking mechanism, therefore, is that deformation of the expander skates is avoided, should these possibly touch the elevator shaft head at the upper end of the elevator shaft, in that the skates 4 of the elevator shaft door unlocking mechanism are designed to be flexible in relation to the elevator car 1. This is ensured, for example, in that, as described, they are mounted displaceably, in each case along a guide 11, on the expander skate structure itself, that is to say on the mounting plate 10. And, as described, these can be implemented in that they are held, spring loaded, in the uppermost displacement position and, by the action of force upon their upper ends from above as a result of collision with the elevator shaft head, can be displaced downward on the mounting plate 10 counter to the force of the springs and, after their upper ends are released, are returned to the uppermost displacement position by these springs.

As an alternative version, however, the elevator shaft door unlocking mechanism may also be configured such that the entire expander skate structure is built on a mounting plate 10 which is itself mounted on the elevator car 1 so as to be flexible in the vertical direction. That is to say, it is guided displaceably, so that, if the upper ends of the expander skates 4 accidentally touch the elevator shaft head, the entire mounting plate 10 can be displaced counter to a spring force and therefore the expander skates 4 arranged on it are flexible over an adjustable distance with respect to the elevator car. As the elevator car 1 moves away from the elevator shaft head, the mounting plate 10 with the expander skates 4 resumes its original position. This construction may be designed such that the mounting plate 10 is mounted displaceably along a dedicated guide, and at the same time being held, spring loaded in the uppermost displacement position. By the action of force on the upper ends of the expander skates 4 attached to it from above as a result of collision with the elevator shaft head, this mounting plate is then displaced downward counter to the force of the springs. And after the release of the upper ends of the expander skates 4, the mounting plate 10 is returned to its uppermost displacement position again by the force of the springs. In both cases, the springs used may be springs of all types, for example steel tension springs 9, steel compression springs, cushion springs, cup springs, gas pressure springs, oil pressure springs, etc., depending on the most preferred design. As a variant, as a result of adapted structures, simple leaf springs made from steel or plastic material may also be used, which are then active between the elevator car 1 and the skates 4 or between the elevator car 1 and the mounting plate 10. A leaf spring made from glass fiber may also prove to be suitable.

In accordance with the provisions of the patent statutes, the present invention has been described in what is considered to represent its preferred embodiment. However, it should be noted that the invention can be practiced otherwise than as specifically illustrated and described without departing from its spirit or scope.

1-10. (canceled)

11. An elevator shaft door unlocking mechanism having a pair of expander skates coupled to a door drive of an elevator car, whereby when the elevator car travels to an access level in an elevator shaft, the door drive moves the expander skates from a locked state to an unlocked state between rollers on a pivoting plate with a pawl on an elevator shaft door, the expander skates pushing the rollers apart from one another and pivoting the pivoting plate to disengage the pawl and thereby unlock the elevator shaft door locking mechanism, comprising: the expander skates being flexibly mounted for movement relative to the elevator car when the expander skates touch a shaft head at an upper end of the elevator shaft, the expander skates moving downwardly from a locked state position an adjustable distance relative to the elevator car and, after the elevator car moves away from the shaft head, the expander skates automatically resuming the locked state position.

12. The elevator shaft door unlocking mechanism according to claim 11 wherein the expander skates are mounted displaceably on a guide on a mounting plate attached to the elevator car, each of the expander skates being biased to the locked state position by a spring, whereby a collision of the expander skates with the shaft head displaces the expander skates downwardly against a force exerted by the springs and, as the elevator car moves downwardly away from the shaft head, the expander skates are returned to the locked state position by the springs.

13. The elevator shaft door unlocking mechanism according to claim 12 wherein at least one of the springs is a steel tension spring.

14. The elevator shaft door unlocking mechanism according to claim 12 wherein at least one of the springs is one of a steel compression spring, a cushion spring and a cup spring.

15. The elevator shaft door unlocking mechanism according to claim 12 wherein at least one of the springs is one of a gas pressure spring and an oil pressure spring.

16. The elevator shaft door unlocking mechanism according to claim 12 wherein at least one of the springs is a leaf spring formed from a steel material.

17. The elevator shaft door unlocking mechanism according to claim 12 wherein at least one of the springs is a leaf spring made from a plastic material.

18. The elevator shaft door unlocking mechanism according to claim 12 wherein at least one of the springs is a leaf spring made from a glass fiber material.

19. The elevator shaft door unlocking mechanism according to claim 11 wherein the expander skates are attached to a mounting plate that is attached to the elevator car displaceably in a vertical direction counter to a spring force applied by at least one spring, whereby when upper ends of the expander skates touch the shaft head, the mounting plate with the expander skates is displaced flexibly over an adjustable distance and, as the elevator car moves away from the shaft head, the mounting plate with the with the expander skates is returned to the locked state position by the at least one spring.

20. The elevator shaft door unlocking mechanism according to claim 19 wherein the mounting plate is mounted displaceably on a guide and is biased by the at least one spring to the locked state position, whereby a collision of the upper ends of the expander skates with the shaft head displaces the mounting plate downwardly against the force exerted by the at least one spring and, as the elevator car moves downwardly away from the shaft head, the mounting plate is returned to the locked state position by the at least one spring.

21. The elevator shaft door unlocking mechanism according to claim 19 wherein the at least one spring is a steel tension spring.

22. The elevator shaft door unlocking mechanism according to claim 19 wherein the at least one spring is one of a steel compression spring, a cushion spring and a cup spring.

23. The elevator shaft door unlocking mechanism according to claim 19 wherein the at least one spring is one of a gas pressure spring and an oil pressure spring.

24. The elevator shaft door unlocking mechanism according to claim 19 wherein the at least one spring is a leaf spring formed from a steel material.

25. The elevator shaft door unlocking mechanism according to claim 19 wherein the at least one spring is a leaf spring made from a plastic material.

26. The elevator shaft door unlocking mechanism according to claim 19 wherein the at least one spring is a leaf spring made from a glass fiber material.
